(19) United States
(12) Patent Application Publication
(10) Pub. No.: US 2012/0045297 A1
(43) Pub. Date: Feb. 23, 2012

(54) ADJUSTABLE TRACTOR ATTACHMENT FOR MOVING HAY BALES

(76) Inventor: Phillip Wayne Smith, Gibsonville, NC (US)

(21) Appl. No.: 12/860,928

(22) Filed: Aug. 22, 2010

(51) Int. Cl. A01D 90/00

(52) U.S. Cl. 414/24.5; 414/800

(57) ABSTRACT

A tractor attachment of the present invention may include a plurality of forks and also may include a spear. The plurality of forks and the spear are each attached to a tractor attachment frame such that the plurality of forks and the spears may be rotated between a lowered position and a raised position. As such, the spears and the forks may be raised or lowered depending on the needs of a user.

### BACKGROUND OF THE INVENTION

1. Field of the Invention

The present invention relates to a tractor attachment for moving bales of hay, and more particularly to such a tractor attachment which can quickly and easily provide a spear and fork options without having to remove any parts. The spear option may include a plurality of spears which may be individually raised and lowered depending on the preferences of a user. The fork option may include multiple forks for picking up a hay bale and a bale engaging member for engaging the top of a hay bale on the forks.

2. Description of Related Art

Hay bales are commonly moved with a spear. For example, as shown on the Tractor House Southeast (volume 4, issue 16, Apr. 16, 2010) cover page, a spear may be attached to a frame in a bucket tractor attachment. This spear is generally used for picking up hay bales in a field. As such, after a field of hay has been baled, it is easy to quickly gather the bales to a single location.

After the hay bales have been gathered to a single location, however, it is often desirable to organize them in a particular manner in order to allow them to be easily moved to another site and to limit the amount of space taken up by the many hay bales from a field. The organization of hay bales with a spear attachment is quite difficult. As such, other types of attachments are used to pick up hay bales.

Other types of attachments may include fork attachments. For example, as shown in Tractor House Southeast (volume 4, issue 16, Apr. 16, 2010) page 16, a set of forks may be used to pick up hay bales along with a claw for holding the hay bale on the top of the forks. These different attachments, however, have limited functionality and cannot be readily changed to meet the needs of a user without changing the entire attachment assembly.

The changing of the attachment assembly usually takes a lot of time, effort, and tooling to remove the first attachment and add the second attachment. The requirement to change the attachments also means that multiple attachments must be taken to each field where hay bales must be gathered and organized. This process is costly and inefficient, especially for small farmers. As such, there is a need for a multi-function attachment which may be quickly adapted to the need of a user.

### SUMMARY OF THE INVENTION

In order to provide the ability to quickly pick up hay bales from a field and to also be able to stack the bales, the present invention provides a tractor attachment which quickly and easily provides both spear and fork type attachment options without having to remove any parts. The spear and fork options can be lowered and raised depending on the preference of the user. For example, when a user wishes to quickly gather hay bales spread across a field, the spear member may be lowered to engage hay bales and a fork member may be raised so that the forks do not interfere with the gathering of the bales. On the other hand, when the user wishes to stack bales, a fork member generally offers better control. As such, the user may raise the spear member so that the spear member does not interfere with the stacking of the bales and the fork members may be lowered to allow the bales to be moved more accurately or stacked the on end.

Both the spear and fork options can also be raised at the same time. As such, the tractor attachment can be driven more safely when not in use and being transported from one field to another or when being moved to or from a storage location. The attachment also lowers the amount of equipment changes necessary by incorporating multiple tools into a single attachment. Additionally, the rotatable parts do not have to be removed and attached to a base unit and, thus, provide a safer and more secure tool. A bale engaging member may also be provided to engage the hay bales from above when the forks are in the lowered position. The spear member, fork member, and bale engaging member may all be attached to a frame.

A spear member may include a single spear that can be lowered or raised to engage hay bales. The spear may be attached to a frame which is attached to a tractor or may be attached to the back of a bucket. The spear member may also be attached to a frame in a bucket or attached to the bucket itself. While the remainder of the application will generally refer to attaching to a frame, it should be understood that other methods of attaching a spear member to the tractor should be known to one of ordinary skill in the art to be equivalent and interchangeable with attaching the various members to a frame.

The spear may be centered along the width of the frame. If a single spear is used, it is preferably provided in the middle of the frame in the vertical and horizontal dimensions of the frame so that the weight of the hay bale is spread across the frame. The spear member may also include multiple spear members. For example, the spear member may include a main spear located in the middle of the frame and smaller auxiliary spears located near the bottom of the frame. Alternatively, the multiple spear members may all be the same size. The auxiliary spears will provide additional support for the weight of the hay bale and will limit the movement of the hay bale when a bale is engaged by the main spear.

The spear member(s) provide an easy to use system for quickly picking up hay bales from a field. The user of the attachment simply has to drive the spears into the bale and can keep moving through the bale when traveling with the bale on the spear to a bale storage location. When all of the bales have been gathered, however, the user of the attachment may find that the spear makes for a clumsy attachment when trying to position the bale in a particular manner, including stacking the bales on end. As such, the spear members of the present invention are not always the best method of positioning bales to be put in storage orientations.

When the user wishes to stack bales, a fork member generally offers better control. As such, the user may desire to remove the spear member to use a different type of attachment such as a fork member. By way of the present invention, the spear members are attached to a frame in such a manner that the front tip of the spears can be raised upwards towards the frame. By removing a pin, the spear member may be released from fixed use position and raised to be positioned against the frame. A pin or other means of securing the spear members may then be inserted into a securing position to secure the spear members into a storage position.

A set of forks may be provided on the outer portions of the bottom of the frame. These forks may also be rotatably attached to the frame, so that the forks may be placed in a storage position up against the frame when the user desires to use the spear, and be lowered to use position when the user desires to use the forks. As such, the spear members will not interfere with the stacking of the bales and the fork members may be lowered to allow the bales to be moved more accurately or staked on end. The forks can be used to more easily manipulate the positioning of the bales, such that the bales can be turned on end or picked up and placed in or on truck beds or the like. The forks can be secured in the storage location by a pin or other securing means in the same manner as the spear members. The forks may be similar to forklift forks.

A bale engaging member may also be provided to engage the hay bales from above when the forks are in the lowered position. For example, the bale engaging member may be a bar, claw or spear which is attached to an arm with a hydraulic cylinder which can be controlled by the user of the tractor attachment. The bale engaging member may be driven up and down by the hydraulic cylinder through an articulating joint that is coupled to the frame. As such, the user of the tractor attachment may be able to drive the bale engaging member down onto the top of a bale which the user has positioned on the ends of the forks. Accordingly, the user may pick up a bale of hay on end and stack the bales in a manner which minimizes the amount of contact the hay has with the ground.

The bale engaging member may have an engaging portion for making contact with a hay bale. In a preferred embodiment, the engaging portion may include a wide bar which is able to stabilize the hay bale. The bale engaging member may have a variety of end attachments such that it can be used in a manner desired by the user. For example, the engaging portion of the bale engaging member may be a flat bar, a bar with spikes protruding downward, a spear, a claw or other implement.

A more complete appreciation along with an understanding of other objects, features, and aspects of the present invention will become apparent from the following detailed description when considered in conjunction with the accompanying drawings.

### BRIEF DESCRIPTION OF THE DRAWINGS

FIG. 1 is a side view of a tractor attachment in accordance with the present invention with the forks down.

FIG. 2 is a side view of the lower portion of the tractor attachment with spear members down.

FIG. 3 is a side view of a tractor attachment in accordance with the present invention with the forks down and a bale engaging member.

FIG. 4 is a side view of a tractor attachment in accordance with the present invention with the spears down and forks in a storage position.

FIG. 5 is another side view of a tractor attachment with spears down attached to a tractor.

FIG. 6 is a side view of a tractor attachment in accordance with the present invention with the forks down and a bale engaging member engaging a hay bale.

FIG. 7 is a side view of a tractor attachment in accordance with the present invention with the forks down and another type of bale engaging member.

FIG. 8 is a view of forks held in a retaining position on the tractor attachment by a pin.

FIG. 9 is a retaining pin for maintaining a main spear member in a retaining position.

FIG. 10 is a retaining pin for maintaining a side spear in a retaining position.

FIG. 11 is a view of a tractor attachment in accordance with the present invention with yet another type of bale engaging member.

### DETAILED DESCRIPTION OF THE INVENTION

The tractor attachment may be attached to a tractor or other vehicle through an attachment arm 30 which may be raised and lowered by an attachment operator. The tractor attachment is based on a frame that is attachable to a tractor arm, and may have quick attach adapters for attaching and removing the attachment from a tractor arm. The frame may include a lower horizontal frame member, an upper horizontal frame member, a central horizontal frame member, a right vertical frame member, a left vertical frame member. The frame may be welded together. The frame may also include a plurality of support members for increasing the strength and rigidity of the frame.

The support members may include a plurality of vertical spear support members, attached to the lower horizontal frame member and the central horizontal support member. The vertical spear support members provide a rotating point for a spear 40.

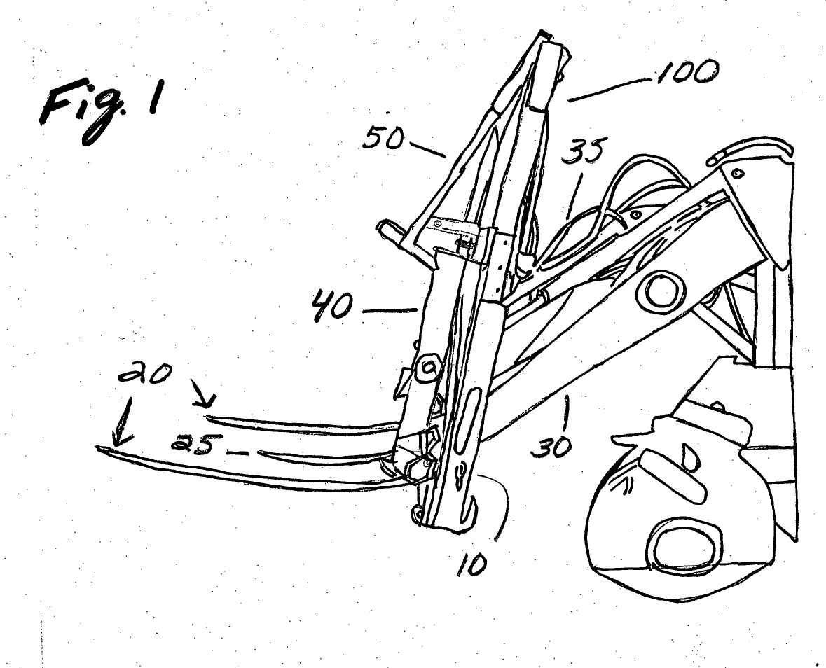

The tractor arm may also be controlled to tilt the attachment in a particular direction based on the arm controls. The tractor attachment also includes a hydraulic cylinder 35 which is coupled to a bale engaging member 50. In FIG. 1, the bale engaging member 50 is in the form of a spear or spike. The bale engaging member may be raised or lowered by controlling the hydraulic cylinder 35, which may be coupled to controls which are positioned in a tractor cabin. The hydraulic cylinder 35 may be coupled to the central horizontal frame member.

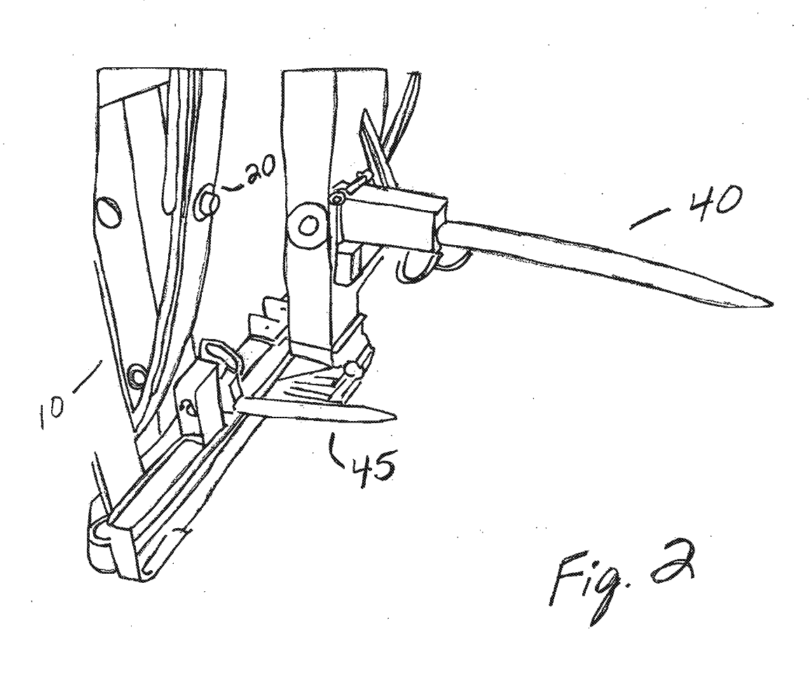

The tractor attachment also includes at least one spear member 40 which is useful, for example, for driving into a hay bale in a field. More particularly, the tractor attachment may include a spear member 40 which may be raised into a storage position which does not interfere with the use of the forks. The spear member may also be lowered, as shown in FIG. 2. The spear member may be coupled to the frame between the lower horizontal frame portion and the central horizontal frame member. The central and lower horizontal frame portions may be wider and may be made of larger tubing that the upper horizontal frame portion. The extra width of the lower portion of the frame is useful for accommodating the forks, and the heavier tubing is useful for limiting frame twisting. The frame may also include multiple vertical frame members.

When a main spear member 40 is lowered, the forks 20 are raised to be held in place against the frame 10 so as not to interfere with the use of the spear member. A plurality of side spear members 45 may also be provided to support the function of the main spear. These side spear members may be provided on either side of the main spear member, and may be rotatable, so that they can be stored against the frame 10 or lowered to be used along with the main spear member.

FIG. 3 depicts the tractor attachment with the forks 20 lowered for use and a main spear member 40 raised and fixed into a position against frame. The bale engaging member 50 has been extended so that it can be used to engage the top of the hay bale. A hydraulic cylinder can be used to drive the bale engaging member 50 down into a bale. The hydraulic cylinder may be mounted to a top of the central horizontal frame member and coupled to the bale engaging member to drive the bale engaging member in a substantially vertical direction.

The bale engaging member may be equipped with a bale engaging member attachment 55 which can be driven into the top of a bale of hay which is sitting on the forks. The bale engaging member attachment 55 in FIG. 3 is a bar member which is used to stabilize the hay bale. The bale engaging member may be coupled to the top of the frame through a pivot point. The pivot point is used to drive the bale engaging member up and down. The bale engaging member attachment 55 is attached to the front of the bale engaging member and a hydraulic cylinder is attached to the back of the bale engaging member.

The bale engaging member attachment 55 is attached to the bale engaging member 50 through a bale engaging member attachment coupling 56. The coupling 56 allows the attachment 55 to be removed or exchanged with another type of attachment. The coupling may also allow the height of the bale engaging member attachment 55 to be adjusted so that the reach of the bale engaging member is either longer or shorter. The bale engaging member may be attached to the top of the top horizontal frame member. The bale engaging member is attached to the frame so that the bale engaging member may be driven up and down in a vertical direction by rotating on the point of attachment to the frame.

FIG. 4 depicts the tractor attachment with the forks 20 raised to be placed in a stored position on the frame. The spears, on the other hand, are lowered so that the spears can be driven into a hay bale. The main spear 40 is coupled to the frame through a pivot point which is located in the portion of the frame which houses the main spear. The main spear is raised so that when the spear is driven into a hay bale, the weight of the hay bale is spread across the frame. The tractor attachment may also have two side spear members 45 which may also be raised and lowered. The side spear members may be distributed nearer to the edges of the frame and may be smaller than the main spear member. The side spear members would not support the whole weight of a hay bale, but would provide support of the hay bale and would minimize the movement hay bale when the main spear is driven into a hay bale.

As shown in FIG. 5, the frame member is attached to a tractor in a known manner so that the attachment can be tilted and raised in the manner necessary to secure a hay bale. The spear members, thus, may be driven into a hay bale and raised and tilted backwards to ensure that the bale is secured against the frame when the vehicle to which the attachment is attached is driving across a hilly field. This tilting ability is also useful in allowing the hay bale to be removed from the tractor attachment when the user has reached the desired location.

Once the hay bale has been delivered to the desired location, the user may then desire to stack the hay bale in a particular manner. The spears on the attachment may then be raised and the forks are lowered. The bale engaging member may also be extended. As shown in FIG. 6, when a user has raised the spear members and lowered the fork members 20, a bale of hay may be picked up on the forks. The spear members are raised to a storage position against the frame 10, and are secured behind the hay bale as shown. The hay bale may then also be secured by the bale engaging member 50 on top of the bale to increase the stability of the hay bale while the user is positioning the bale in the desired manner. The bale engaging member may be used to secure the bale against the forks or may be used to help rotate or position the bale.

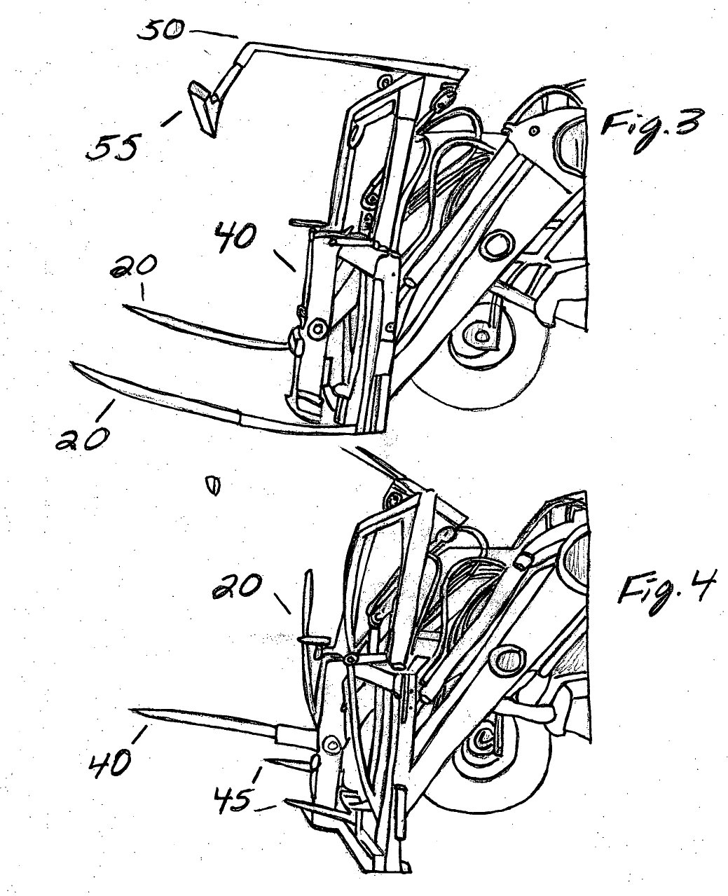

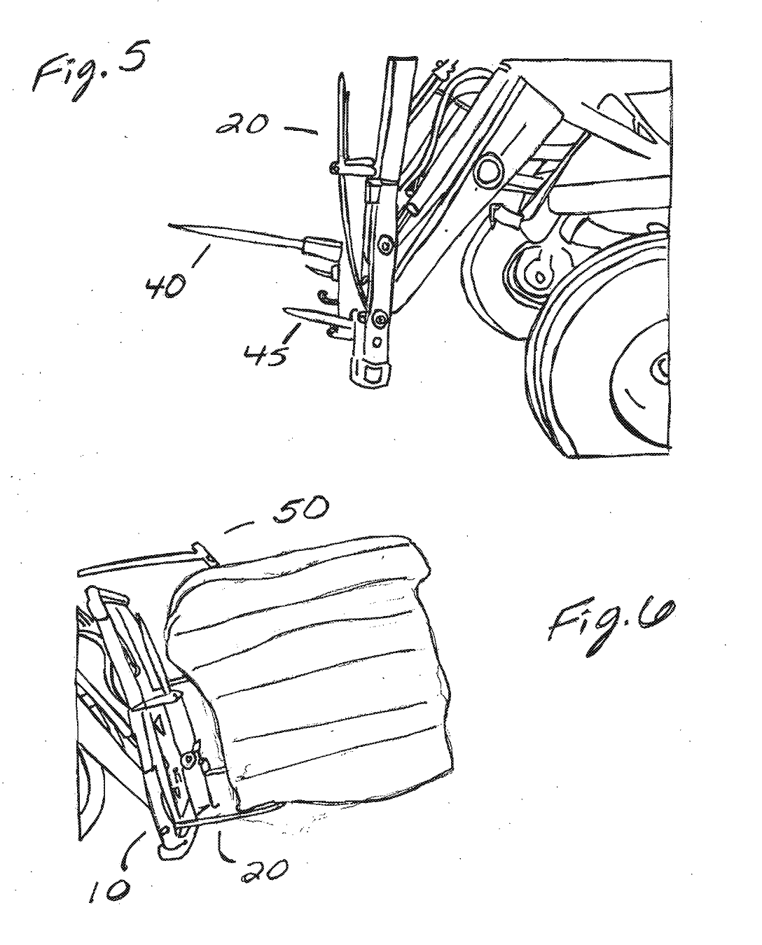

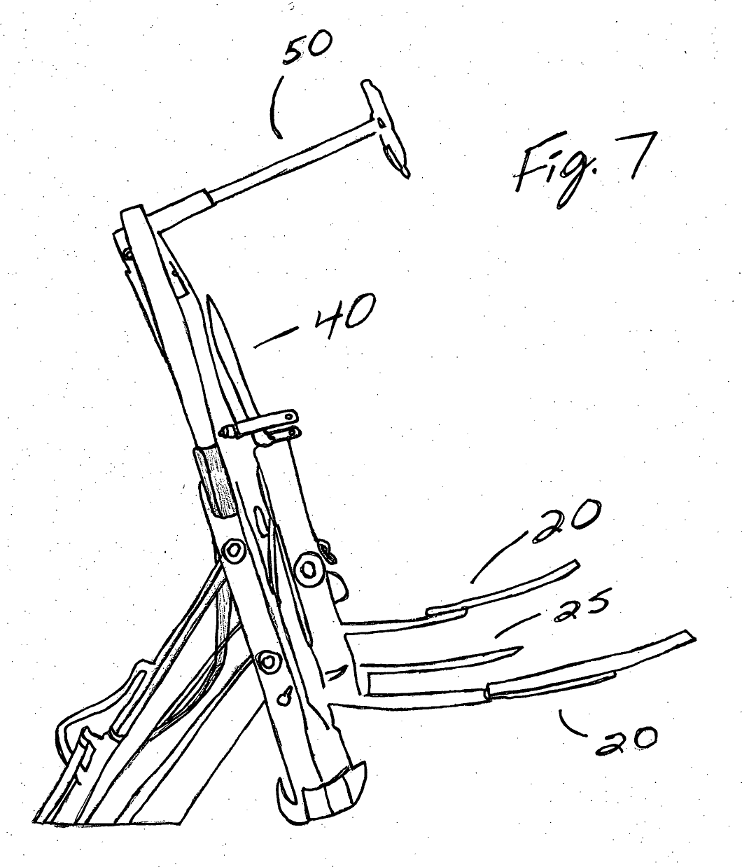

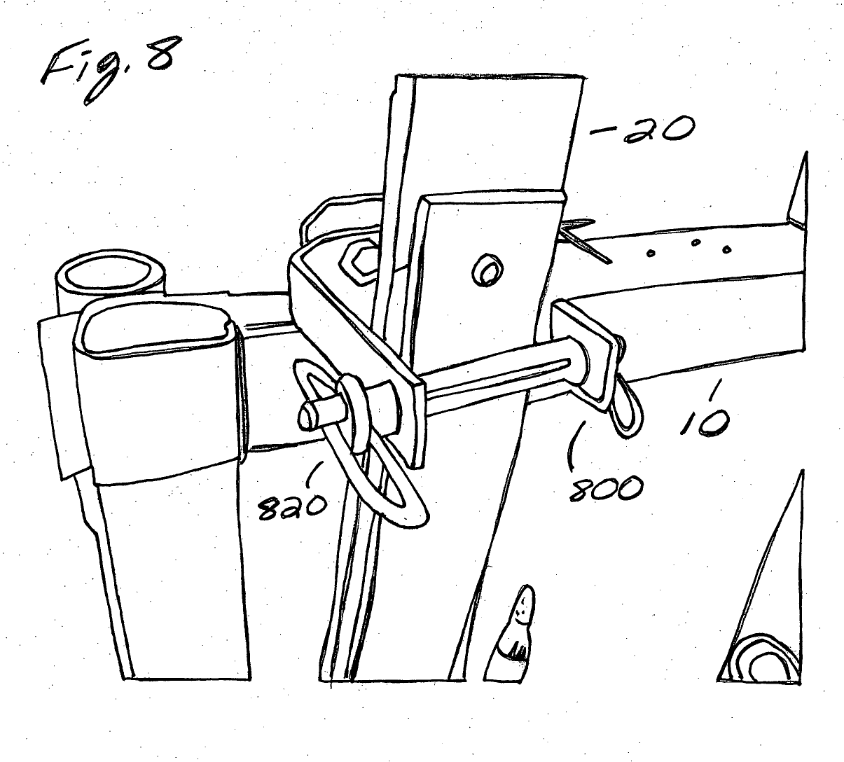

The tractor attachment may be used to separate portions of the hay bale when the bale has been positioned for use. For example, as shown in FIG. 7, the attachment may include a bale engaging member 50 with a spear type end. When the main forks 20 and auxiliary fork 25 are lowered, the bale engaging member may be used to secure the bale against the forks. However, the bale engaging member may also be used when the forks are raised and positioned against the frame in the same manner as the main spear member 40 shown in the FIG. 7. As such, the bale engaging member 50 with a spear type end may also be used to break up a bale which has been positioned for consumption or other use.

When the forks are raised, they must be secured against the frame. FIG. 8 depicts a fork 20 being stored against the frame 10. A U-shaped bracket 800 has been attached to the frame to secure the fork 20. The forks are secured in the bracket 800 by a pin 820, when may be secured into position by a clip or recessed button in order to ensure that the pin does not fall out. The spears may also be secured to the frame in a similar manner. The main forks may be positioned near the exterior of the frame, and an auxiliary spear may be positioned interior to a main fork.

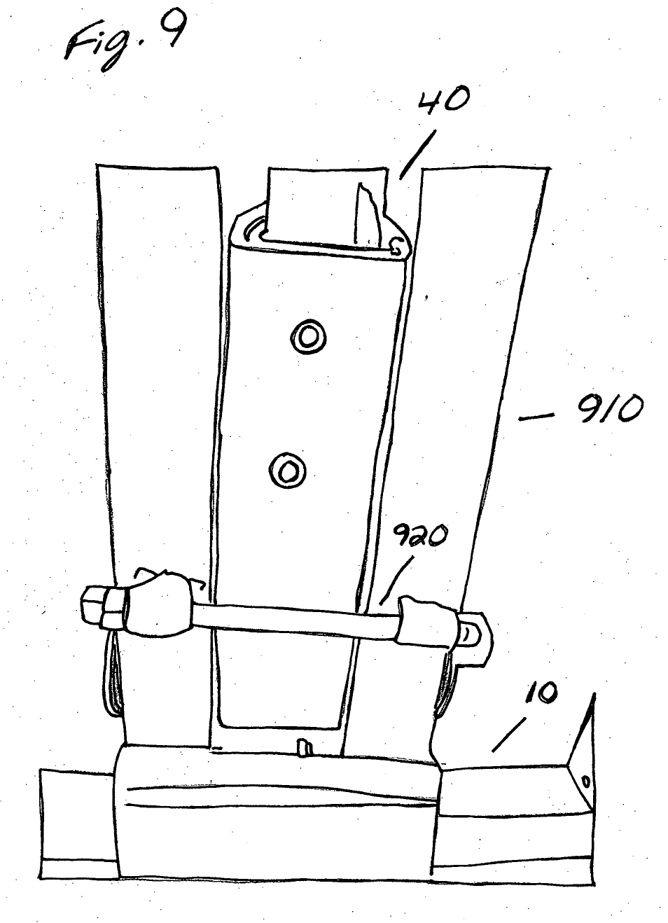

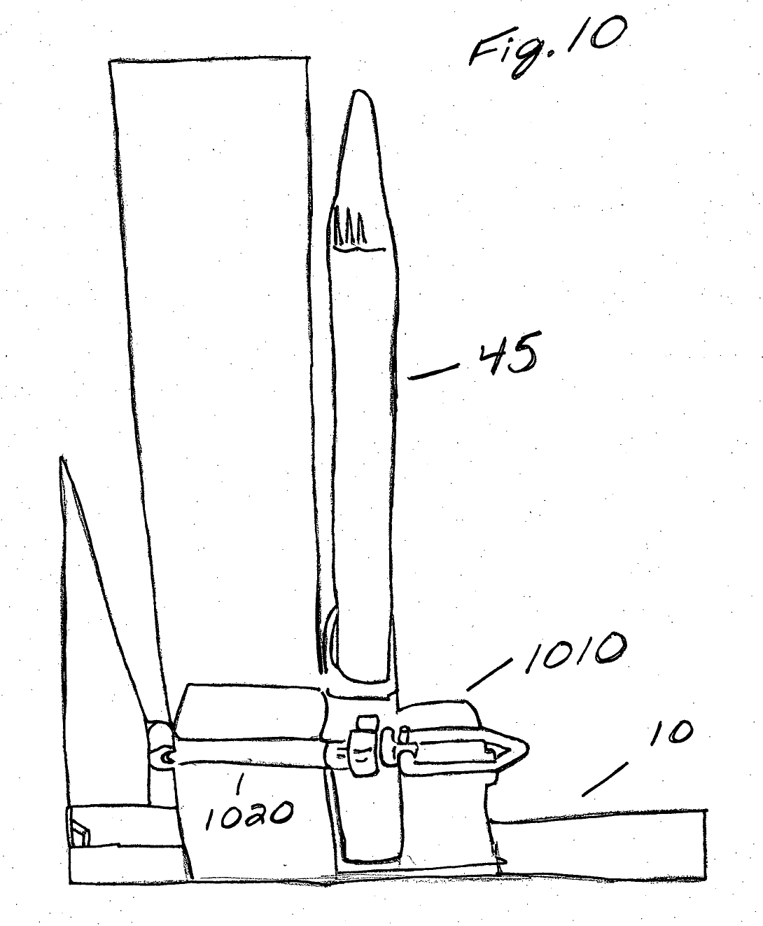

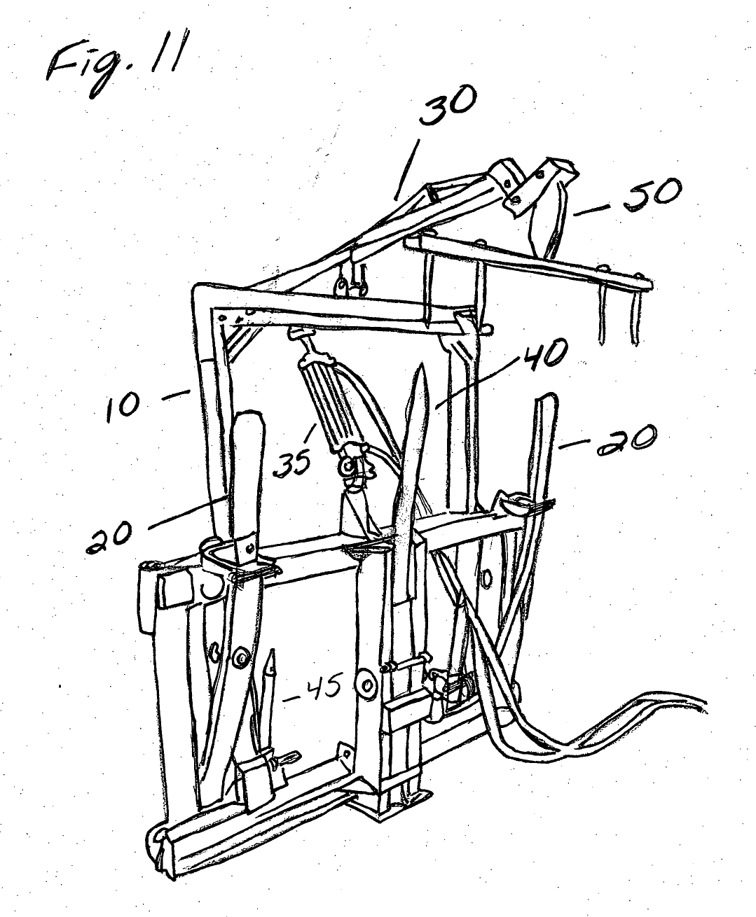

In a similar manner, as shown in FIG. 9, vertical spear support members 910, attached to the lower and central horizontal frame members, provide a place to secure the main spear 40 in place with a spear securing pin 920. The pin may be placed to secure the spear in a raised position and removed so that the spear can be lowered for use. When the spear has been lowered, the pin may be replaced, in the pin holders attached to the vertical spear support members, so that the spear does not begin to raise when the spear is being driven into a bale of hay. As shown in FIG. 10, the auxiliary or side spear members 45 may also be held in place by a securing pin 1020 which is secured in pin holders attached to the frame. The pin holder may be secured to a vertical frame portion the frame may include additional protruding portions to provide a place to mount the pin holder and to allow the spears to be rotatably mounted to the frame.

FIG. 11 shows the entire tractor attachment. The bale engaging member 30 is coupled to the top of the frame 10, and is connected to the hydraulic cylinder 35, which is also attached to the frame. As such, the bale engaging member attachment 50, which is attached to the bale engaging member 30, may be driven down in a vertical direction when the hydraulic cylinder is extended. Accordingly, the tips on the bale engaging member attachment 50 may be driven down into the top of a bale of hay. In FIG. 11, the forks 20, the main spear 40 and the auxiliary spears 45 are all shown in the raised position.

The frame 10, in FIG. 11, includes a central horizontal frame member and a lower horizontal frame member. A number of extra frame portions may be provided to improve the strength and rigidity of the frame. For example, these extra frame portions may include triangular bracing portions for strengthening the connection between vertical and horizontal frame members. The central and lower horizontal frame members may wider than the width of an upper horizontal frame member. These portions of the frame may also be made of heavier material in order to support a greater portion of the load weight. The forks may be mounted to the lower horizontal frame member in a rotatable manner and may be secured outside of vertical frame members which connect a lower horizontal frame member and an upper horizontal frame members, and inside vertical frame members connecting the lower horizontal frame member and the central horizontal frame member. A fork securing member, such as the U-shaped member depicted, may be used to secure the forks in a raised storage position. These U-shaped member may be attached to the central horizontal frame member or may be attached to a vertical frame member running from the lower frame member to the central or upper frame member.

A spear 40 is attached to the frame between the lower and central horizontal frame members. The spear may be secured between to vertical frame portions that support and strengthen the frame. The spear may be attached between these portions to rotate between a lowered position and a raised position. The vertical spear frame portions may run between the lower and central horizontal frame members or may be attached to front of the lower and central horizontal frame members. The spear member may be secured using a pin between a plurality of vertical frame portions or may be secured using a U-shaped securing member in the same manner as shown with respect to the forks of FIG. 11.

The tractor attachment need not include a bale engaging member 30, as shown. Instead, the frame may include only the lower and central horizontal frame members. In such a case, fork members and a spear member or plurality of spear members may still be provided, even though a bale engaging member and hydraulic cylinder for driving the bale engaging member may not be provided. However, when the frame does include a vertical horizontal frame member, at least two vertical frame members will run from the lower horizontal frame member to the vertical horizontal frame member. The hydraulic cylinder may be connected to the central horizontal frame member or secured between the central horizontal frame member and the upper horizontal frame member by attaching to a vertical frame member running therebetween. The optimal position for attaching the hydraulic cylinder may depend on the size of the hydraulic cylinder and the desired amount of travel of the bale engaging member when the bale engaging member is being driven up and down.

While the present invention has been described with respect to what is presently considered to be the preferred embodiments, the present invention is not limited to the disclosed embodiments. Rather, the present invention covers various modifications and equivalent arrangements included within the spirit and scope of the appended claims. The scope of the appended claims is to be accorded the broadest interpretation so as to encompass all such modifications and equivalent structures and functions.

What is claimed is:

1. A tractor attachment which attaches to a tractor for moving hay bales and for picking up hay bales, the tractor attachment comprising:
a frame member which is removably attachable to a tractor arm, wherein the frame portion include a lower horizontal frame member, an upper horizontal frame member, a central horizontal frame member, a right vertical frame member, a left vertical frame member;
a spear member, useful for spearing a hay bale, rotatably coupled to the lower horizontal frame member of the said frame member, wherein said spear member is rotatable between a lowered position, where a tip of said spear member is directed away from said frame member, and a raised position, where a tip of said spear member is directed towards said upper horizontal portion of said frame member;
a spear securing member for securing the spear in one of the raised position and the lowered position;
a plurality of fork members rotatably attached to said lower horizontal frame member, wherein said plurality of fork members includes at least a first fork and a second fork which are attached to the lower horizontal frame member in such a manner that said first and second forks are rotatable between a lowered position, where tips of said forks are directed away from said frame member, and a raised position, where the tips of said forks are directed towards said upper horizontal portion of said frame member;
a plurality of fork securing members, coupled to the central horizontal frame member, for securing said forks in the raised position;
an engaging member, coupled to said upper horizontal frame portion to rotate in a vertical direction; and
a hydraulic cylinder, coupled to said engaging member, for driving said engaging member in the vertical direction to rotate said engaging member on said upper horizontal frame member.

2. The tractor attachment according to claim 1, further comprising:
a bale engaging member attachment, coupled to said engaging member, for engaging a hay bale when said engaging member is driven in the vertical direction by said hydraulic cylinder.

3. The tractor attachment according to claim 2, wherein said bale engaging member attachment includes a horizontal attachment member and a plurality of vertical attachment members which extend downward from said horizontal attachment member.

4. The tractor attachment according to claim 1, wherein said bale engaging member attachment includes a horizontal attachment member and a plurality of vertical attachment members which extend downward from said horizontal attachment member.

5. A tractor attachment, comprising:
a frame;
a spear member attached to said frame, wherein said spear member may be rotated between a lowered position and a raised position;
a plurality of fork members attached to said frame, wherein said plurality of fork members may be rotated between a lowered position and a raised position; and
a plurality of securing members for securing said spear member and said plurality of fork members in their respective raised positions.

6. The tractor attachment of claim 5, further comprising an engaging member attached to said frame, such that said engaging member may be rotated to engage a hay bale sitting on the plurality of fork members.

7. The tractor attachment of claim 6, further comprising a hydraulic cylinder, attached to the engaging member, for driving said engaging member in a substantially vertical direction.

8. The tractor attachment of claim 5, wherein said spear member attached to said frame by a rotatable fixture such that said spear member may be placed in a down position for engaging the hay bale in a substantially horizontal manner and an up position for storing said spear member when the spear member is not to be used for engaging the hay bale.

9. The tractor attachment of claim 5, wherein said spear member, attached to said frame, is substantially centered along the width of said frame.

10. The tractor attachment of claim 5, wherein said plurality of fork members includes a first fork member and second fork member attached to said frame near the bottom of said frame and said first fork member and said second fork member are attached near opposite edges along the width of said frame.

11. The tractor attachment of claim 5, wherein said securing members include a plurality of U-shaped securing members for securing said plurality of fork members in the raised position.

12. The tractor attachment of claim 5, further comprising plurality of auxiliary spear members, including a first and second auxiliary spear attached to said frame on opposite sides of said frame member.

13. A method of using a tractor attachment, the tractor attachment including at least a frame, a spear member attached to the frame, a plurality of forks attached to the frame, and a plurality of securing members for securing the spear member and the plurality of forks in a selected position, the method comprising steps of:
when the spear member is in the raised position and the forks are in the lowered position, (a) removing the spear securing member, lowering the spear member from a raised position close to the frame to a lowered position, and replacing the spear securing member to secure the spear in the lowered position, and (b) removing fork securing members, raising the forks from the lowered position to the raised position close to the frame, and replacing the fork securing members to secure the forks in the raised position; and
when the spear member is in the lowered position and the forks are in the raised position, (a) removing the spear securing member, raising the spear member from a lowered position to a raised position close to the frame, and replacing the spear securing member to secure the spear in the raised position, and (b) removing fork securing members, lowering the forks from the raised position close to the frame to the lowered position, and replacing the fork securing members.

14. The method of using a tractor attachment according to claim 13, the tractor attachment further comprising an engaging member attached to said frame, the method further comprising a step of:
rotating the engaging member to engage a hay bale sitting on the plurality of forks.

15. The method of using a tractor attachment according to claim 14, the tractor attachment further comprising a hydraulic cylinder, attached to the engaging member, the method further comprising a step of:
engaging the hydraulic cylinder to drive the engaging member in a substantially vertical direction.

16. The method of using a tractor attachment according to claim 13, wherein the spear member attached to the frame by a rotatable fixture such that the spear member may be placed in a down position for engaging the hay bale in a substantially horizontal manner and an up position for storing the spear member when the spear member is not to be used for engaging the hay bale.

17. The method of using a tractor attachment according to claim 13, wherein the spear member is attached to the frame at substantially a center along the width of the frame.

18. The method of using a tractor attachment according to claim 13, wherein the plurality of fork includes a first fork and second fork attached to the frame near the bottom of the frame and the first fork and the second fork are attached near opposite edges along the width of the frame.
